(19) United States
(12) Patent Application Publication
(10) Pub. No.: US 2022/0361496 A1
(43) Pub. Date: Nov. 17, 2022

(54) HERBICIDE COMPOSITIONS

(71) Applicants: UPL CORPORATION LIMITED, Port Louis (MU); UPL EUROPE LTD, Warrington, Chesire (GB)

(72) Inventors: Carlos Eduardo FABRI, Port Louis (MU); Rafael Henriq PEREIRA, Port Louis (MU); Ferdinando Marcos Lima SILVA, CEP (BR); Giuvan LENZ, CEP (BR)

(73) Assignees: UPL CORPORATION LIMITED, Port Louis (MU); UPL EUROPE LTD, Warrington, Chesire (GB)

(21) Appl. No.: 17/765,665

(22) PCT Filed: Oct. 1, 2020
(86) PCT No.: PCT/IB2020/059196

§ 371 Date: Mar. 31, 2022

(30) Foreign Application Priority Data
Oct. 1, 2019 (IN) 201941039822

(51) Int. Cl. A01N 43/647; A01N 43/50; A01P 13/00; A01N 37/26; A01N 43/90

(52) U.S. Cl. CPC A01N 43/647; A01N 43/50; A01P 13/00; A01N 37/26; A01N 43/90

(57) ABSTRACT

The present invention relates to herbicidal combinations. More specifically, the subject of this invention relates to a combination of shoot growth inhibitor herbicides with amino-acid synthesis inhibitor herbicides for controlling weeds.

### FIELD OF INVENTION

The present invention relates to herbicidal combinations. More specifically, the subject of this invention relates to a composition comprising combination of shoot growth inhibitor herbicides with amino-acid synthesis inhibitor herbicides for controlling weeds.

### BACKGROUND OF INVENTION

Herbicides are pesticides useful for killing or controlling unwanted plants. Generally, there are two kinds of herbicides-selective and non-selective. Selective herbicides kill certain target weeds while leaving the desired crop relatively unharmed while non-selective herbicides kill both the weeds and crops. Profitable crop production depends on effective weed control. The weeds can reduce field crop yields by competing for water, sunlight and nutrients. In today's crop production systems, starting off with a good burn-down program is a must as it helps to achieve maximum initial crop growth and reduce weed interference during early stages of the crop cycle. Since the weed-crop competition is critical during the early stages of crop cycle, the weed interference at early stage has a direct impact on the yield of the crop.

An effective weed control can be achieved by usage of herbicides appropriately. The activity of herbicides can be enhanced in various ways to achieve the maximum benefit. One of the ways is to use combinations. However, identifying appropriate combinations, their agrochemical application rates and ratio of the combinations is essential to achieve efficacious control, which is not straight forward. The selection of a particular formulation type is more cumbersome for an agrochemical combination. Thus, herbicides play an important role for weed control in crop production. Applying combinations of herbicidal compounds may enhance the herbicidal effectiveness.

Propisochlor has been tested on a very large number of crops; it has been found to be very interesting for many of the crops tested, particularly for maize, sunflower and rapeseed. The weeds that occur on these crops and on which propisochlor allows an interesting control are mainly: —grasses: Echinochloa crus-galli; Setaria sp; Digitaria sanguinalis; Apera spica venti; Poa annua; Sorghum halepense; broadleaf weeds: Capsella Bursa Pastoris; Amaranthus retroflexus; Chenopodium spp.; Matricaria spp; Galium Aparine. Propisochlor can be applied at different key stages of the crop, i.e. pre-planting (with or without incorporation into the soil), post-sowing/pre-emergence, which is its preferred or post-emergence position (such as sugarcane or early stages on maize), the application of the herbicide to be carried out “around sowing” on weeds not yet emerged or at a very young stage. When in combinations with other herbicides like here proposed the application on weeds can be in post-emergence with weeds emerged and or with true leaves stage. However, there remains a great need for improved broadleaf and grassy weed control compositions and a method of controlling such noxious vegetation in pre and post emergence without adversely affecting desirable plants and which reduces the amount of chemical herbicidal agent necessary to obtain the acceptable weed control.

### SUMMARY OF INVENTION

In one aspect, the present invention provides a herbicidal combination comprising:
(a) at least one shoot growth inhibitor and
(b) at least one herbicide selected from amino-acid synthesis inhibitors.

In another aspect, the present invention provides a herbicidal composition comprising combination of
(a) at least one chloroacetamide herbicide and
(b) at least one amino-acid synthesis inhibitor.

In an aspect, the present invention provides a herbicidal composition comprising:
(a) at least one shoot growth inhibitor,
(b) at least one amino-acid synthesis inhibitor and
(c) at least one agrochemically acceptable excipient.

In another aspect, the present invention provides a method of controlling weeds at a locus, said method comprising applying to the locus a herbicidal combination comprising:
(a) at least one shoot growth inhibitor and
(b) at least one amino-acid synthesis inhibitor

Yet another aspect of the present invention provides a method of increasing yield in a crop by application of a combination comprising:
(a) at least one shoot growth inhibitor and
(b) at least one amino-acid synthesis inhibitor

Another aspect of the present invention provides a method of improving the plant health, said method comprising application at the locus of the plant a combination comprising:
(a) at least one shoot growth inhibitor and
(b) at least one amino-acid synthesis inhibitor.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about” and is meant to encompass variations of ±10%, ±5%, ±1%, ±0.5%, or even ±0.1% of the specified value as well as the specified value.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation.

The terms “plants” and “vegetation” include, but are not limited to, germinant seeds, emerging seedlings, plants emerging from vegetative propagules, and established vegetation. The term “weed” refers to unwanted vegetation and includes any plant which grows where it is not wanted, including pesticide resistant plants. The terms “undesirable vegetation”, “harmful plants”, “unwanted plants”, “weeds” and “weed species”, as used herein, are synonyms.

Typically, the combinations/compositions of the present invention are applied to the targeted weed or to their locus or to the crop/plant. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other herbicides or fungicides or insecticide or plant growth promoting agents or adjuvants or excipients not specifically recited therein.

It was surprisingly found that a synergistic interaction was observed when certain shoot growth inhibitor herbicides were combined with certain other amino acid inhibitors.

These shoot growth inhibitors target the long chain fatty acid synthesis in the membrane, and thus prevent the formation of cell membranes.

It has been found that these shoot growth inhibitors demonstrate synergistic activity in the presence of other amino acid inhibitors. One such amino acid inhibitor is the Acetolactate Synthase (ALS) or Acetohydroxy Acid Synthase (AHAS) Inhibitor.

The ALS inhibitors target the ALS enzyme, and thus prevents the production of certain amino-acids and thus certain proteins in the plant.

Accordingly, the present invention provides a herbicidal combination comprising:
(a) at least one shoot growth inhibitor; and
(b) at least one amino-acid synthesis inhibitor.

In an embodiment, the amino-acid synthesis inhibitor is Acetolactate Synthase (ALS) or Acetohydroxy Acid Synthase (AHAS) Inhibitors.

In one embodiment, the present invention provides a herbicidal combination comprising:
(a) at least one shoot growth inhibitor; and
(b) at least one Acetolactate Synthase (ALS)

In one embodiment the shoot growth inhibitor is a herbicide belonging to chloroacetamide compounds.

Therefore, in one aspect, the present invention may provide a herbicidal combination comprising:
(a) at least one chloroacetamide herbicide; and
(b) at least one amino-acid synthesis inhibitor.

In another aspect the present invention may provide a herbicidal combination comprising:
(a) at least one chloroacetamide herbicide; and
(b) at least one Acetolactate Synthase (ALS) or Acetohydroxy Acid Synthase (AHAS) Inhibitors.

In accordance with the present invention there is provided a herbicidal combination comprising a shoot growth inhibitor belonging to chloroacetamide herbicide and a second active, amino-acid synthesis inhibitor for controlling weeds.

In an embodiment, the herbicide belonging to chloroacetamide is selected from, but not limited to acetochlor, alachlor, amidochlor, butachlor, butenachlor, delachlor, diethatyl, dimethachlor, ethachlor, ethaprochlor, metazachlor, metolachlor, S-metolachlor, pretilachlor, propachlor, propisochlor, prynachlor, terbuchlor, thenylchlor and xylachlor.

In an embodiment, the herbicide belonging to chloroacetamide is propisochlor. It penetrates through the underground organs of weeds during germination or at the seedling stage. On the one hand, it inhibits the synthesis of proteins and nucleic acids, on the other hand it inhibits root growth. The reduction in osmotic potential resulting from these actions causes the rapid death of weeds.

Examples of a combination according to the invention are, but are not limited to, described hereinafter.

In an embodiment the present invention provides a combination comprising
a) Propisochlor and
b) at least one ALS inhibitors or AHAS inhibitor herbicide.

In an embodiment, the ALS inhibitor or AHAS inhibitor herbicide is selected from the group consisting of:
(i) an imidazolinone herbicide;
(ii) a sulfonylamino-carbonyltriazolinone herbicide;
(iii) a sulfonylurea herbicide;
(iv) a pyrazole herbicide;
(v) a triazolpyramidine herbicide; and
(vi) a triazolone herbicide;

In an embodiment, the ALS inhibitor or AHAS inhibitor herbicide is an imidazolinone herbicide.

In an embodiment, the imidazolinone herbicide is selected from the group consisting of imazamethabenz, imazamox, imazapic, imazapyr, imazaquin, and imazethapyr.

In an embodiment, the imidazolinone herbicide is imazamox.

In an embodiment, the imidazolinone herbicide is imazapic.

In an embodiment, the imidazolinone herbicide is imazapyr.

In an embodiment, the imidazolinone herbicide is imazethapyr.

In an embodiment, the ALS inhibitor is a triazolone herbicide.

In an embodiment, the triazolone herbicide is selected from the group consisting of amicarbazone, bencarbazone, carfentrazone, flucarbazone, ipfencarbazone, propoxycarbazone, sulfentrazone, and thiencarbazone.

In an embodiment, the triazolone herbicide is carfentrazone.

In an embodiment, the triazolone herbicide is flucarbazone.

In an embodiment, the triazolone herbicide is sulfentrazone.

In an embodiment, the triazolone herbicide is amicarbazone

In an embodiment, the ALS inhibitor herbicide is a sulfonylamino-carbonyltriazolinone herbicide.

In an embodiment, the sulfonylamino-carbonyltriazolinone herbicide is flucarbazone.

In an embodiment, the sulfonylamino-carbonyltriazolinone herbicide is flucarbazone-sodium.

In an embodiment, the sulfonylamino-carbonyltriazolinone herbicide is Propoxycarbazone.

In an embodiment, the sulfonylamino-carbonyltriazolinone herbicide is Thiencarbazone.

In an embodiment, the ALS inhibitor herbicide is a sulfonylurea herbicide.

In an embodiment, the sulfonylurea herbicide is selected from the group consisting of amidosulfuron, azimsulfuron, bensulfuron, chlorimuron, cyclosulfamuron, ethoxysulfuron, flazasulfuron, flucetosulfuron, flupyrsulfuron, foramsulfuron, halo sulfuron, imazosulfuron, mesosulfuron, metazosulfuron, methiopyrisulfuron, mono sulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, pro sulfuron, thifensulfuron, triasulfuron, tribenuron, trflusulfuron, and tritosulfuron.

In an embodiment, the sulfonylurea herbicide is bensulfuron.

In an embodiment, the sulfonylurea herbicide is halo sulfuron.

In an embodiment, the sulfonylurea herbicide is pyrazosulfuron.

In an embodiment, the sulfonylurea herbicide is pyrazosulfuron ethyl.

In an embodiment, the sulfonylurea herbicide is sulfosulfuron.

In an embodiment, the sulfonylurea herbicide is trifloxysulfuron.

In an embodiment, the sulfonylurea herbicide is metsulfuron or S-metsulfuron.

In an embodiment, the sulfonylurea herbicide is flazasulfuron.

In an embodiment, the ALS inhibitor herbicide is a pyrazole herbicide.

In an embodiment, the pyrazole herbicide is selected from the group consisting of azimsulfuron, cyclopyranil, difenzoquat, halosulfuron, flazasulfuron, metazachlor, metazosulfuron, pyrazosulfuron, pyrazosulfuron ethyl, pyraclonil, pyroxasulfone, benzofenap, pyrasulfotole, pyrazolynate, pyrazoxyfen, tolpyralate, topramezone, fluazolate, nipyraclofen, pinoxaden, and pyraflufen.

In an embodiment, the pyrazole herbicide is metazachlor.

In an embodiment, the pyrazole herbicide is pinoxaden.

In an embodiment, the pyrazole herbicide is pyraflufen.

In an embodiment, the ALS inhibitor herbicide is a triazolopyrimidine herbicide.

In an embodiment, the triazolopyrimidine herbicide is selected from the group consisting of chloransulam, diclosulam, florasulam, flumetsulam, metosulam, penoxsulam, and pyroxsulam.

In an embodiment, the triazolopyrimidine herbicide is diclosulam.

In an embodiment, the triazolopyrimidine herbicide is penoxsulam.

In an embodiment, the ALS inhibitor herbicide is selected from the group consisting of imazamox, imazapic, imazapyr, imazethapyr, carfentrazone, flucarbazone, sulfentrazone, flucarbazone, amicarbazone, flucarbazone-sodium, bensulfuron, halo sulfuron, pyrazosulfuron, pyrazosulfuron ethyl, flazasulfuron, sulfosulfuron, trifloxysulfuron, metsulfuron, metazachlor, S-metalochlor, pinoxaden, pyraflufen, diclosulam, and penoxsulam.

Examples of a combination/composition in present composition according to the invention are, but are not limited to, the embodiments described hereinafter

In an embodiment the present invention provides a combination comprising
a) Propisochlor and
b) imazaquin

In an embodiment the present invention provides a combination comprising
a) Propisochlor and
b) imazapyr.

In an embodiment the present invention provides a combination comprising
a) Propisochlor and
b) flazasulfuron

In an embodiment the present invention provides a combination comprising
a) Propisochlor and
b) diclosulam

In an embodiment the present invention provides a combination comprising
a) Propisochlor and
b) Sulfentrazone

In an embodiment, the combinations of the present invention as described above may comprise propisochlor and two or more herbicides from the same and different class defined above.

The composition of the invention further comprises other additional active ingredients such as other herbicides, antidotes, fungicides, insecticides, acaricides, fertilizers.

In another aspect the present invention provides a herbicidal combination comprising:
a) at least one chloroacetamide herbicide;
b) at least one Acetolactate Synthase (ALS) or Acetohydroxy Acid Synthase (AHAS) Inhibitors and
c) at least one agrochemically acceptable excipient.

In an aspect, the present invention provides a herbicidal combination comprising the combinations described above in any one of the embodiments and a third active ingredient.

In an embodiment, the third active ingredient of the present combinations may be those selected from but not limited to herbicide, insecticide, fungicide, biological agent, plant growth activator, fertilizers or combinations thereof.

In an embodiment, the third active ingredient is a herbicide.

In an embodiment, the third herbicide is not the same herbicide of first and second herbicide, although they can be a combination of two herbicides from the same class or group of herbicides.

Accordingly, the present invention provides a combination comprising
(a) a shoot growth inhibitor;
(b) a ALS inhibitor herbicide and
(c) a third herbicide.

In another embodiment, the present invention provides a combination comprising
(a) a chloroacetamide herbicide;
(b) a ALS inhibitor herbicide and
(c) a third herbicide.

Exemplary third herbicides that may be combined with the combination of the present invention may be selected from but not limited to herbicides for example, Accase inhibitors (acetyl CoA carboxylase) for example Aryloxyphenoxy-propionate, Phenylpyrazoline and Cyclohexanedione, 5-enolpyruvylshikimate-3-phosphate (EPSP) Synthase Inhibitor, Hydroxyphenylpyruvate dioxygenase (HPPD) inhibitors, synthetic auxin inhibiters, protoporphyrinogen oxidase (PPO) inhibitor, Glutamine Synthetase Inhibitor, Microtubule Inhibitors, lipid synthesis inhibitors, long chain fatty acid inhibitors, cell wall inhibitors, cell division inhibitors, sulfonylureas, Carotenoid Biosynthesis Inhibitors, bleaching inhibitors, Cellulose Inhibitors, Photosystem inhibitors such as Photosystem II Inhibitors, Photosystem I (PSI) Electron Diverter, inhibitor of the enzyme phytoene desaturase (PDS) as well as herbicides with unknown modes of action.

In an embodiment, the third active is photo system II inhibitor.

In an embodiment, the photo system II inhibitor selected from the group consisting of

(i) a phenylcarbamate herbicide;

(ii) a triazine herbicide;

(iii) a triazinone herbicide;

(iv) an uracil herbicide;

(v) a benthiadiazole herbicide;

(vi) a nitrile herbicide; and

(vii) an urea herbicide;

In an embodiment, the third active is 4-(4-hydroxyphenyl-pyruvate dioxygenase) HPPD inhibitor.

In an embodiment, 4-HPPD inhibitor is selected from a group comprising isoxazole, pyrazolone and triketone or callistemone herbicides.

In an embodiment 4-HPPD inhibitor is an isoxazole herbicide.

In an embodiment 4-HPPD inhibitor is a pyrazolone herbicide.

In an embodiment 4-HPPD inhibitor is a triketone herbicide.

In an embodiment 4-HPPD inhibitor is a callistemone herbicide.

In an embodiment 4-HPPD inhibitor is selected from benzobicyclon, benzofenap, bicyclopyrone, fenquinotrione, isoxachlortole, isoxaflutole, mesotrione, pyrasulfotole, pyrazolynate, pyrazoxyfen, sulcotrione, tefuryltrione, tembotrione, tolpyralate, topramezone.

In an embodiment 4-HPPD inhibitor is fenquinotrione.

In an embodiment 4-HPPD inhibitor is mesotrione.

In an embodiment 4-HPPD inhibitor is sulcotrione.

In an embodiment 4-HPPD inhibitor is tembotrione.

In an embodiment 4-HPPD inhibitor is topramezone.

Accordingly, the present invention provides a combination comprising
(a) a shoot growth inhibitor;
(b) a ALS inhibitor herbicide and
(c) HPPD inhibitor

In an embodiment, the third active is PPO inhibitor selected from diphenylether, N-phenylphthalimide, Phenylpyrazole Oxadiazole, Thiadiazole, triazolinone, Oxazolidinedione and pyrimidinedione herbicides.

In an embodiment, PPO inhibitor is diphenylether.

In an embodiment, PPO inhibitor is N-phenylphthalimide.

In an embodiment, PPO inhibitor is aryl triazoinone.

In an embodiment, PPO inhibitor is pyrimidinedione.

In an embodiment, PPO inhibitor is selected from acifluorfen, fomesafen, lactofen, flumiclorac, flumioxazin, sulfentrazone, carfentrazone, fluthiacet-ethyl and saflufenacil, azafenidin, benzfendizone, bifenox, butafenacil, carfentrazone, carfentrazone-ethyl, chlomethoxyfen, cinidon-ethyl, fluazolate, flufenpyr-ethyl, flumiclorac-pentyl, fluoroglycofen-ethyl, fluthiacet-methyl, fomesafen, halosafen, lactofen, oxadiargyl, oxadiazon, oxyfluorfen, pentoxazone, profluazol, pyraclonil, pyraflufen-ethyl, saflufenacil, thidiazimin, trifludimoxazin and tiafenacil.

In an embodiment, the third active is microtubule assembly inhibitor is selected from benzamide, benzoic acid, dinitroaniline and pyridine herbicides.

In an embodiment, the third active is microtubule assembly inhibitor is dinitroaniline herbicide.

In another embodiment, the microtubule assembly inhibitor is selected from Benzamide, Benzoic acid, Dinitroaniline, Phosphoroamidate amiprophos and Pyridine herbicides.

In an embodiment, the microtubule assembly inhibitor is selected from benfluralin, butralin, dinitramine, oryzalin, pendimethalin, trifluralin, Propyzamide, DCPA, Pendimethalin, Ethalfluralin, Oryzalin, Trifluralin, Prodiamine, Dithiopyr, Thiazopyr, or methyl butamiphos.

In another embodiment, the third active is cellulose biosynthesis inhibitor is selected from Alkylazine, Benzamide and Nitrile Triazolocarboxamide herbicides.

In an embodiment, cellulose biosynthesis inhibitor is selected from Dichlobenil, chlorthiamide, Indaziflam, Isoxaben, Dichlobenil and flupoxam.

In an embodiment cell division inhibitor is selected from chloroacetamide, acetamide, oxyacetamide and tetrazolinone herbicides.

In an embodiment cell division inhibitor is selected from acetochlor, alachlor, butachlor, dimethachlor, dimethenamid, metazachlor, S-metolachlor, metolachlor, pethoxamid, pretilachlor, propisochlor, thenylchlor, diphenamid, napropamide, naproanilide, flufenacet, mefenacet, fentrazamide, propachlor, anilofos, cafenstrole, piperophos, DSMA and MSMA.

In an embodiment the third active is leaching inhibitor selected from triazoles, triketones, isoxazoles, pyrazole, pyridazinone, pyridinecarboxamide,

Isoxazolidinone, urea, diphenylether amitrole, mesotrione, sulcotrione, Isoxazoles, isoxachlortole, isoxaflutole, benzofenap, pyrazolynate, pyrazoxyfen, pyridazinone, norflurazon, pyridinecarboxamide, diflufenican, picolinafen, Isoxazolidinone, clomazone, fluometuron, aclonifen, beflubutamid, fluridone, flurochloridone, flurtamone, bromobutide (chloro)-flurenol, cinmethylin, cumyluron, dazomet, dymron, methyl-dimuron, etobenzanid, fosamine, indanofan, metam, oxaziclomefone oleic acid, pelargonic acid and pyributicarb.

Example of other herbicides that may be combined with the combination of the present invention may be selected from but not limited to, topramezone, Orthosulfamuron, Pinoxaden, Metamifop, Pyrimisulfan, Tembotrione, Thiencarbazone methyl, Flucetosulfuron, Aminopyralid, Pyrasulfotole, Saflufenacil, Pyroxsulam, Pyroxasulfone, Pyraclonil, Indaziflam, Fenquinotrione, Florpyrauxifen-benzyl, Tiafenacil, Cinmethylin, Lancotrione-Sodium, Bixlozone, Trifludimoxazin, Cyclopyrimorate, Methiozolin, Aminocyclopyrachlor, Metazosulfuron, Ipfencarbazone, Fenoxasulfone, Bicyclopyrone, Triafamone, Halauxifen methyl, Tolpyralate or combinations thereof.

In an embodiment the present invention provides a combination comprising:
a) Propisochlor,
b) Flazasulfuron and
c) third active ingredient.

In an embodiment the present invention provides a combination comprising:
a) Propisochlor;
b) Imazaquin and
c) third active ingredient.

In an embodiment the present invention provides a combination comprising:
a) Propisochlor,
b) Imazapyr and
c) third active ingredient.

In an embodiment the present invention provides a combination comprising:
a) Propisochlor;
b) Diclosulam and
c) third active ingredient.

In an embodiment, the present invention provides compositions and methods of use thereof to provide resistance to one or more herbicides.

In an embodiment, the present invention provides composition.

In an embodiment, the compositions of the present invention comprise a herbicidal composition described in any one of the embodiments and an agrochemically acceptable excipient.

In one embodiment, the present invention provides a herbicidal composition for controlling weeds said composition comprising:
a) at least one shoot growth inhibitor;
b) at least one Acetolactate Synthase (ALS) and/or Acetohydroxy Acid Synthase (AHAS) Inhibitors and
c) at least one agrochemically acceptable excipient.

The composition of the invention may further comprise other subsequent active ingredients such as other herbicides, antidotes, fungicides, insecticides, acaricides, fertilizers.

In an aspect the present invention provides a herbicidal composition for controlling weeds comprising
(a) a shoot growth inhibitor;
(b) a ALS inhibitor herbicide and
(c) a third herbicide along with at least one agrochemically acceptable excipient.

The compositions of the present disclosure can be employed in combination with known herbicide safeners, such as benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148 and N-phenyl-sulfonylbenzoic acid amides, to enhance their selectivity.

Optionally, a composition can include an adjuvant. An adjuvant may be used with the composition to enhance or improve herbicidal performance. Adjuvants may be added to the composition at the time of formulation, or by the applicator to the spray mix just prior to treatment. Adjuvants include surfactants, compatability agents, anti-foaming agents and spray colorants (dyes), and drift control agents. In certain embodiments, the adjuvant is an ethoxylated propoxylated fatty amine or a polyether-polymethylsiloxane-copolymer.

As disclosed herein, the compound combinations, in addition to being well tolerated by crops, have herbicidal activities and can be used in a variety of crops for selectively controlling weed. Non-limiting examples of crops include maize, wheat, sugar cane, barley, rice, citrus, palm trees, pineapple, cucurbits, beans, soybeans, agave, cassava, turf and pasture.

The combinations of the present invention can also be used for controlling undesired vegetation in non-crop areas, e.g. fallow agricultural land. The term “non-crop area” used herein refers to areas where a crop, or any intentionally planted vegetation, is not grown. The term “fallow agricultural land” used herein refers to a piece of land where no crop or pasture is growing. A fallow agricultural land that is not used for crops, may be left unused in order to restore its natural fertility.

In various embodiments, the herbicidal activity of a combination according to the invention exceeds the total of the activities of the individual active compounds. If there are two active compounds, the activity will be greater than the sum of the single active compound alone. Thus, in various embodiments, herbicidal compositions include compositions synergistic for control of one or more weeds.

The compositions of the invention have been found to be active herbicides in possessing herbicidal activity against one or more species of weeds. In the broadest sense, the term “weed” refers to plants which grow in locations in which they are not desired. In other words, a weed is a plant in which in the context of a crop is undesirable due to competition for water, nutrients, sunlight, soil, etc.

The use of the combinations/compositions according to the invention provides for excellent herbicidal effectiveness against a broad spectrum of economically important mono- and dicotyledonous annual weeds and perennial weeds.

The compositions of the invention can be used, for example, in control of one or more of following plants (weeds):

Monocotyledonous weeds include the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Dicotyledonous weeds include the genera: Abutilon, Amaranthus, Ambrosia, Anoda, Anthemis, Aphanes, Atriplex, Bellis, Bidens, Capsella, Carduus, Cassia, Centaurea, Chenopodium, Cirsium, Convolvulus, Croton, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Merremia, Momordica, Mullugo, Myosotis, Papaver, Pharbitis, Plantago, Polygonum, Portulaca, Ranunculus, Raphanus, Ricinus, Rorippa, Rotala, Rumex, Salsola, Senecio, Sesbania, Sida, Sinapis, Solanum, Sonchus, Sphenoclea, Stellaria, Stizolobium, Taraxacum, Thlaspi, Trifolium, Urtica, Veronica, Viola, Xanthium.

The use of the active compound combinations according to the invention is in no way restricted to these genera, but also extends in the same manner to other plants. Depending on the concentration, the herbicidal compositions are suitable for selective weed control in crops, for example, cereals, rice, maize, sorghum, sugar cane, cotton, canola, soya, turf, barley, potato, sweet potato, sunflower, rye, oats, wheat, corn, soybean, sugar beet, safflower, alfalfa, cassava, cucurbits, pineapple and pastures.

Specific weed species encountered in corn include, but not limited to, Ixophorus unisetus, Amaranthus hybridu, Ipomoea purpurea, and Sicyos angulata. Specific weed species encountered in sugar cane include, but not limited to, Acalypha sp., Boerhavia erecta, Trianthema portulacastrum, Amaranthus hybridus, and Amaranthus lividus, weed species encountered in soybean include, but not limited to, Brachiaria decumbens Eleusine indica Cenchrus echinatus Ipomoea grandifolia or Commelina benghalensis.

In particular embodiments, a synergistic effect of the compound combinations according to the invention is present. As used herein, the term “synergism” means that the herbicidal action of the active compound combination exceeds the action of the active compounds when applied individually on a given weed, either pre- or post-emergent.

The herbicidal compositions can be in customary formulations, such as solutions, emulsions, wettable powders, suspensions, powders, dusts, pastes, soluble powders, granules, suspo-emulsion concentrates, emulsifiable concentrate, oil spray, aerosol, natural and synthetic materials impregnated with active compound, and very fine capsules in polymeric substances. In certain embodiments, the compositions is in a form of an emulsifiable concentrate, wettable powder, granule, dust, oil spray or aerosol.

These formulations can be produced, for example by mixing the active compounds with agrochemically acceptable ingredients which include but not limited to, extenders, that is liquid carriers and/or solid carriers, one or more dispersants, wetting agents, fillers, surfactants, anticaking agents, pH-regulating agents, preservatives, biocides, antifoaming agents, colorants and other formulation aids.

In the case of the use of water as an extender, organic solvents can, for example, also be used as auxiliary solvents. Liquid solvents include aromatics, such as xylene, toluene or alkylnaphthalenes, chlorinated aromatics and chlorinated aliphatic hydrocarbons, such as chlorobenzenes, chloroethylenes or methylene chloride, ali-phatic hydrocarbons, such as cyclohexane or paraffins, for example petroleum fractions, mineral and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, as well as water.

As solid carriers there are suitable, for example, ammonium salts and ground natural minerals, such as kaolins, clays, talc, chalk, quartz, attapulgite, mont-morillonite or diatomaceous earth, and ground synthetic minerals, such as finely divided silica, alumina and silicates, as solid carriers for granules there are suitable: for example crushed and fractionated natural rocks such as calcite, marble, pumice, sepiolite and dolomite, as well as synthetic granules of inorganic and organic meals, and granules of organic material such as sawdust, coconut shells, maize cobs and tobacco stalks; as emulsifying and/or foam-forming agents there are suitable: for example nonionic and anionic emulsifiers, such as polyoxyethylene fatty acid esters, poly-oxyethylene fatty alcohol ethers, for example alkylaryl polyglycol ethers, alkylsulphonates, alkyl sulphates, aryl-sulphonates as well as protein hydrolysates; as dispersing agents there are suitable: for example lignin-sulphite waste liquors and methylcellulose.

Adhesives such as carboxymethylcellulose and natural and synthetic polymers in the form of powders, granules or latexes, such as gum arabic, polyvinyl alcohol and polyvinyl acetate, as well as natural phospholipids, such as cephalins and lecithins, and synthetic phospholipids, can be used in the formulations.

Colourants can also be included in the formulations. Non-limiting examples are inorganic pigments, such as iron oxide, titanium oxide and Prussian Blue, and organic dyestuffs, such as alizarin dyestuffs, azo dye-stuffs and metal phthalocyanine dyestuffs, and trace nutrients such as salts of iron, manganese, boron, copper, cobalt, molybdenum and zinc.

The formulations are prepared according to procedures which are conventional in the agricultural chemical art, but which are novel and important because of the presence therein of a combinations/composition of the present invention. Herbicidal compositions according to the invention can be applied in the form of ready mixes. Herbicidal compositions can also be formulated individually and mixed upon use, i.e. applied in the form of tank mixes.

Herbicidal compositions can be used as such or in the form of their formulations, for particular application purposes, in particular when applied post-emergence, formulations such as mineral or vegetable oils which are tolerated by plants or ammonium salts such as, for example, ammonium sulphate or ammonium thiocyanate, as further additives can be included.

Herbicidal compositions can be used as such, in the form of their formulations or in the forms prepared therefrom by dilution of a concentrated form, such as ready-to-use or concentrated solutions, suspensions, emulsions, powders, pastes and granules. They are used in the customary manner, for example by watering, spraying, atomizing, dusting or scattering. Herbicidal compositions according to the invention can be applied before and after the plants have emerged, that is to say pre-emergence and post-emergence. They can also be incorporated into the soil before, during or after sowing seeds of a crop. The invention also provides methods for controlling undesirable plants or vegetation. In one embodiment, a method includes applying to a crop where control of such vegetation is desired, an herbicidally effective amount of a composition. Such methods include a composition of the invention, optionally together with an adjuvant, an inert diluent or a carrier suitable for use with an herbicide.

The acceptable carrier may be any one or a combination of adjuvants, co-solvents, surfactants, colorants, emulsifiers, thickeners, antifreeze agents, biocides, anti-foam agents, stabilizers, wetting agents or a mixture thereof which may be optionally added to the compositions of the present invention. The surfactants may be selected from non-ionic, anionic or cationic surfactants.

These combinations as described above may be applied to the locus of the weeds, in an herbicidally effective amount.

In an embodiment, the total amount of the shoot growth inhibitors (chloroaceamide) herbicide in the composition may be in the range of 0.1 to 99% by weight, preferably 0.2 to 90% by weight.

In an embodiment, the total amount of the second active or third active in the composition may be in the range of 0.1 to 99% by weight.

In an embodiment, the constituent herbicides of the composition of the present invention may be admixed in ratio of (1-80):(1-80) or (1-80):(1-80):(1-80) respectively.

In an embodiment the combinations/compositions of the present invention are applied at application rate from about 0.001 kg a.i./ha to 5.0 kg a.i./ha, preferably from about 50 g a.i./ha to 2500 g a.i./ha, more preferably from about 100 g a.i./ha to 2000 g a.i./ha.

Yet, the weight ratios of individual components can be varied within relatively wide ranges. Typically, there are 1:100 to 100:1 parts by weight of the active compounds.

In an embodiment the combinations/compositions according to the invention are applied to the soil's surface prior to weed emergence, then either the weed seedlings are prevented completely from emerging, or the weeds grow to seedling stage, but then their growth stops and finally, after three to four weeks, they die completely.

The herbicidal combination of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, sugarcane etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, Zelkova, Japanese arborvitae, fir wood, hemlock, juniper, Pinus, Picea, and Taxus cuspidate, etc.

In a preferred embodiment, the crop plant is selected from the group consisting of wheat, barley, rye, triticale, oat, corn (maize), sunflower, rice, soybeans, peas, beans, peanuts, oilseed rape, canola, cotton, potato, sugarbeet, sugarcane, turfgrasses and vegetables.

The target weeds may be selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE) or Xanthium strumarium (common cocklebur, XANST).

According to an embodiment, the weeds targeted are grassy weeds and broad-leaved weeds.

In an embodiment, the weed removal is not restricted to crop land or agricultural land only. The weeds are targeted in non-agricultural areas such as, but not limited to, forestries, railways, infrastructure, amenities, companies, factories, roads and runways, sidewalks, highways, dividers, medians, pipelines, public utility lines, pumping stations, transformer stations, substations, around airports, electric utilities, commercial buildings, manufacturing plants, storage yards, rail yards, hangars, fence lines, parking lots, parkways, sedges, post-harvest crop lands, beneath greenhouse benches and around golf courses.

In an aspect, the present invention provides a method of controlling weeds or selective control or total kill of weeds at the locus, said method comprising applying to the locus present herbicidal combinations.

In another aspect, the present invention may provide a method of controlling weeds at a locus, said method comprising applying to weed or to their locus or to crop a herbicidal combination comprising:
(a) a shoot growth inhibitor and
(b) at least one amino-acid synthesis inhibitor.

In one embodiment, the shoot growth inhibitor is chloroacetamide compound in the composition of present invention, is propisochlor.

In an embodiment, the present invention may provide a method of controlling weeds at a locus, said method comprising applying to the locus a herbicidal combination comprising:
(a) propisochlor and
(b) at least one Acetolactate Synthase (ALS) or Acetohydroxy Acid Synthase (AHAS) Inhibitors.

Yet another aspect of the present invention may provide a method of increasing yield in a crop by application of a combination comprising:
(a) a shoot growth inhibitor and
(b) at least one amino-acid synthesis inhibitor.

Another aspect of the present invention may provide a method of improving the plant health, said method comprising application at the locus of the plant a combination comprising:
(a) a shoot growth inhibitor and
(b) at least one amino-acid synthesis inhibitor.

In an embodiment the shoot growth inhibitor is chloroacetamide compound, said amino-acid synthesis inhibitors Acetolactate Synthase (ALS) or Acetohydroxy Acid Synthase (AHAS) Inhibitor

The herbicide combinations/compositions of the present invention are synergistically effective in controlling weeds.

This mixture is selective to crops such as soybean, corn and sugarcane and the herbicides molecules complement each other effect over the weed control. The synergy between them allows, with a lower dose, a better weed control and greater selectivity for crops.

The use of pre-emergent is a key tool for resistance management, controlling weeds that are already resistant to herbicides and preventing the emergence of new resistant species.

In an embodiment the present combinations/compositions are applied in pre-emergent application.

In an embodiment, the combinations of the present invention may be applied to the locus either simultaneously or separately or sequentially and is capable of providing a synergistic herbicidal effect. In an embodiment the two or three herbicides may be applied in a tank mix or as a pre-mixed composition.

The compositions according to the invention are applied to the plants mainly by spraying. Here, the application can be carried out using, for example, water as carrier by customary spraying techniques using spray liquor amounts of from about 50 to 1000 l/ha (for example from 200 to 500 l/ha). The herbicidal compositions may also be applied by the low-volume or the ultra-low-volume method, or in the form of microgranules. The herbicidal compositions according to the present invention can be applied pre- or post-emergence of the unwanted vegetation.

The present combinations/compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In an embodiment the present invention provides use of the present combinations/compositions for controlling undesirable vegetation in a pre-emergence treatment.

In an embodiment the present invention provides use of the herbicidal combination comprising: (a) at least one shoot growth inhibitor; and (b) at least one amino-acid synthesis inhibitors for controlling undesirable vegetation.

In an embodiment, there is provided a kit-of-parts comprising an instructions manual, said instructions manual comprising instructions directing a user to admix the components before being used.

In an embodiment, the components of the present invention may be packaged such that the chloroacetamide herbicide and at least one another herbicide defined above may be packaged separately and then tank mixed before the spraying.

In another embodiment, the components of the present invention may be packaged such that chloroacetamide herbicide and at least one another herbicide defined above may be packaged separately, whereas other additives are packaged separately, such that the two maybe tank mixed at the time of spraying.

In another embodiment, the components of the present invention may be packaged as composition such that chloroacetamide herbicide and at least one another herbicide defined above are formulated into one composition and other additives are packaged separately, such that the two maybe tank mixed at the time of spraying.

The invention also provides methods for selective control of weeds. In one embodiment, a method includes contacting a composition of the invention onto a crop plant in need of weed control or at risk of undesirable weeds, in an amount effective to provide weed control in the crop.

Herbicidal activity of the compound combinations can be seen from the examples which follow. While the individual active compounds show less activity with regard to herbicidal activity, certain combinations have a herbicidal activity which exceeds a simple sum of the activity of the individual active compounds.

These combinations or compositions as described above may be applied to the weed or to locus of the weeds or to the plant/crop, in synergistically effective amount. It can be seen from the use examples herein below that the found herbicidal action of the active compound combinations according to the invention exceeds the calculated value, that is to say that the new active compound combinations have a synergistic effect in controlling weeds.

This effectiveness of all treatments can be evaluated according to Colby's equation. In the Colby's equation given below, E is the expected efficacy of combination of Propisochlor and another herbicide, X is the observed efficacy of Propisochlor and Y is the observed efficacy of other herbicide. Observed efficacy values i.e. X and Y are % weed control for Propisochlor and another herbicide. If observed efficacy of combination of Propisochlor and other herbicide is greater than its expected efficacy, then combination is determined to be synergistic. If observed efficacy is equal to or less than expected efficacy, then combination is determined to be non-synergistic.

E=X+Y−XY/100 Colby's equation

The results of synergistic effects of the present combinations/compositions is represented in examples.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. A number of embodiments of the invention have been described. Nevertheless, it will be understood that various modifications may be made without departing from the spirit and scope of the invention.

These and other advantages of the invention may become more apparent from the examples set forth herein below. These examples are provided merely as illustrations of the invention and are not intended to be construed as a limitation thereof.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein.

Experiments were carried out evaluate the efficacy, selectivity and synergism of propisochlor combinations when applied at soybean pre-emergence.

### Example 1

The effect of the herbicidal compositions according to the invention of herbicides combinations on the growth of undesirable plants was compared to the herbicidally active compounds alone and demonstrated by following experiments. The evaluation for the damage on undesired weeds caused by the compositions was carried out using a scale from 0 to 100%, compared to the untreated control plants. Here, 0 means no damage and 100 means complete destruction of the plants.

The tables 1 below relate to the herbicidal activity, of the individual actives and the combinations applied in pre-emergence application at 35 days after administration (DAA) treatment.

TABLE 1
Table 1: Efficacy of Propisochlor +
Diclosulam was represented in table below.

| | | | % Control of |
|---|---|---|---|
| | Active | Dose | Brachiaria plantaginea |
| Treatment | ingredient | (g ai/ha) | 35 DAA |
| 1 | Control | — | 0 |
| 2 | propisochlor | 1200 | 84.50 |
| 3 | Diclosulam | 20 | 50.0 |
| 4 | propisochlor + | 1200 + 50 | 93.75 |
| | Diclosulam | | |
| 5 | propisochlor + | 1440 + 24 | 95.50 |
| | Diclosulam | | |

TABLE 2
Table 2: Efficacy of Propisochlor +
Sulfentrazone was represented in table below.

| | | | % Weed control | |
|---|---|---|---|---|
| | | | 35 DAA | |
| | Active | Dose | Ipomoea | Spermacoce |
| Treatment | ingredient | (g ai/ha) | hederifolia | verticillata |
| 1. | Control | — | 0 | 0 |
| 2. | Propisochlor | 525 | 26.25 | 92.75 |
| 3. | Propisochlor | 675 | 27 | 95.75 |
| 4. | Sulfentrazone | 75 | 98.00 | 92.25 |
| 5. | Propisochlor + | 525 + 75 | 100.00 | 99.50 |
| | Sulfentrazone | | | |
| 6. | Propisochlor + | 675 + 75 | 100.00 | 100.00 |
| | Sulfentrazone | | | |

TABLE 3
Table 3: Efficacy of Propisochlor +
Sulfentrazone was represented in table below.

| | | | % Control |
|---|---|---|---|
| | Active | Dose | 35 DAA |
| Treatment | ingredient | (g ai/ha) | Brachiaria plantaginea |
| 1. | Control | — | 0 |
| 2. | Propisochlor | 1200 | 84.50 |
| 3. | Sulfentrazone | 150 | 65.00 |
| 4. | Propisochlor + | 1200 + 150 | 96.75 |
| | Sulfentrazone | | |

### Example 2

TABLE 4
Table 4: Efficacy of Propisochlor + imazaquin and
Propisochlor + imazapyr was represented in table below.

| | | | % Control - | | |
|---|---|---|---|---|---|
| | Active | Dose | Cenchrus echinatus | | |
| Treatment | ingredient | (g ai/ha) | 7 DAA | 28 DAA | 35 DAA |
| 1 | Control | — | 0.0 | 0.0 | 0.0 |
| 2 | propisochlor | 540.0 | 91.3 | 75.8 | 65.0 |
| 3 | propisochlor | 1080.0 | 95.3 | 85.0 | 80.0 |
| 4 | imazaquin | 80.5 | 18.8 | 10.0 | 6.3 |
| 5 | imazapyr | 26.6 | 3.8 | 0.0 | 0.0 |
| 6 | propisochlor + | 540 + | 97.5 | 97.8 | 95.3 |
| | imazaquin | 80.5 | | | |
| 7 | propisochlor + | 1080 + | 98.0 | 99.0 | 98.5 |
| | imazaquin | 80.5 | | | |
| 8 | propisochlor + | 540 + | 95.8 | 95.8 | 90.8 |
| | imazapyr | 26.6 | | | |
| 9 | propisochlor + | 1080 + | 96.8 | 88.0 | 81.3 |
| | imazapyr | 26.6 | | | |

TABLE 5
Efficacy of Propisochlor + imazaquin and Propisochlor +
imazapyr and was represented in table below.

| | | | % Control of | | | |
|---|---|---|---|---|---|---|
| | Active | Dose | Brachiaria decumbens | | | |
| Treatment | ingredient | (g ai/ha) | 7 DAA | 14 DAA | 21 DAA | 28 DAA |
| 1 | Control | — | 0 | 0 | 0 | 0 |
| 2 | propisochlor | 540 | 89.5 | 85.8 | 78.8 | 70 |
| 3 | propisochlor | 1080 | 92.8 | 91 | 85 | 76.3 |
| 5 | imazaquin | 80.5 | 30 | 22.5 | 21.3 | 18.8 |
| 6 | imazapyr | 26.6 | 30 | 12.5 | 6.3 | 2.5 |
| 7 | propisochlor + | 540 + 80.5 | 98.5 | 97.5 | 97.3 | 95.5 |
| | imazaquin | | | | | |
| 8 | propisochlor + | 1080 + 80.5 | 99.5 | 99 | 98.5 | 98.3 |
| | imazaquin | | | | | |
| 9 | propisochlor + | 540 + 26.6 | 98 | 95.3 | 88.8 | 83.3 |
| | imazapyr | | | | | |
| 10 | propisochlor + | 1080 + 26.6 | 96.3 | 93.8 | 86.3 | 78.8 |
| | imazapyr | | | | | |

TABLE 6
Efficacy of Propisochlor + imazapyr was represented in table below.

| | | | % Control of | | | | |
|---|---|---|---|---|---|---|---|
| | Active | Dose | Ipomoea grandifolia | | | | |
| Treatment | ingredient | (g ai/ha) | 7 DAA | 14 DAA | 21 DAA | 28 DAA | 35 DAA |
| 1 | Control | — | 0 | 0 | 0 | 0 | |
| 2 | propisochlor | 540 | 81.3 | 87.0 | 87.5 | 91.3 | 91.8 |
| 3 | imazapyr | 66.6 | 16.3 | 30.0 | 51.3 | 62.5 | 63.8 |
| 4 | propisochlor + | 540 + 66.6 | 89.8 | 92.0 | 94.5 | 97.8 | 99.0 |
| | imazapyr | | | | | | |

As can be seen from the data in Tables, the combination of propisochlor and herbicides belonging to amino-acid synthesis inhibitor group exhibits an unexpected synergistic effect in that the herbicidal activity against various weed species in a pre-emergence treatment is significantly higher than would be predicted based on the values for each of the compounds individually.

1. A herbicidal combination comprising:
at least one shoot growth inhibitor; and
at least one herbicide, wherein the at least one herbicide is an amino-acid synthesis inhibitor.

2. The combination according to claim 1, wherein said at least one shoot growth inhibitor is a chloro acetamide compound.

3. The combination according to claim 1, wherein said amino-acid synthesis inhibitor is an Aceto lactate Synthase (ALS) inhibitor or an Acetohydroxy Acid Synthase (AHAS) inhibitor.

4. The combination according to claim 21, wherein said at least one shoot growth inhibitor is a chloro acetamide compound selected from the group consisting of acetochlor, alachlor, amidochlor, butachlor, butenachlor, delachlor, diethatyl, dimethachlor, ethachlor, ethaprochlor, metazachlor, metolachlor, S-metolachlor, pretilachlor, propachlor, propisochlor, prynachlor, terbuchlor, thenylchlor, and xylachlor.

5. The combination according to claim 1, wherein said amino acid synthesis inhibitor is selected from the group consisting of an imidazolinone herbicide, a sulfonylamino-carbonyltriazolinone herbicide, a sulfonylurea herbicide, a pyrazole herbicide, a triazolpyramidine herbicide, and a triazolone herbicide.

6. The combination according to claim 5, wherein said imidazolinone herbicide is selected from the group consisting of imazamethabenz, imazamox, imazapic, imazapyr, imazaquin, and imazethapyr.

7. The combination according to claim 5,
wherein said triazolone herbicide is selected from the group consisting of amicarbazone, bencarbazone, carfentrazone, flucarbazone, ipfencarbazone, propoxycarbazone, sulfentrazone, and thiencarbazone; and
wherein said sulfonylamino-carbonyltriazolinone herbicide is selected from the group consisting of flucarbazone, flucarbazone-sodium, Propoxycarbazone, and Thiencarbazone

8. The combination according to claim 5, wherein said sulfonylurea herbicide is selected from the group consisting of amidosulfuron, azimsulfuron, bensulfuron, chlorimuron, cyclosulfamuron, ethoxy sulfuron, flazasulfuron, flucetosulfuron, flupyrsulfuron, foramsulfuron, halo sulfuron, imazo sulfuron, mesosulfuron, metazo Sulfuron, methiopyrisulfuron, monosulfuron, nicosulfuron, ortho sulfamuron, oxasulfuron, primisulfuron, propyrisulfuron, pyrazol Sulfuron, rimsulfuron, sulfometuron, sulfo Sulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, triflusulfuron and tritosulfuron.

9. The combination according to claim 5,
wherein said pyrazole herbicide is selected from the group consisting of azimsulfuron, cyclopyranil, difenzoquat, halo sulfuron, flazasulfuron, metazachlor, metazo sulfuron, pyrazo sulfuron, pyrazo sulfuron ethyl, pyraclonil, pyroxasulfone, benzofenap, pyrasulfotole, pyrazolynate, pyrazoxyfen, tolpyralate, topramezone, fluazolate, nipyraclofen, pinoxaden, and pyraflufen; and
wherein said triazolopyrimidine herbicide is selected from the group consisting of chloransulam, diclosulam, florasulam, flumetsulam, metosulam, penoxsulam, and pyroxsulam.

10. The herbicidal combination according to claim 1 further comprising
at least one third herbicide.

11. The combination according to claim 10, wherein said at least one third herbicide is selected from the group consisting of an ACCase (acetyl CoA carboxylase) inhibitor, a 5-enolpyruvylshikimate-3-phosphate (EPSP) Synthase Inhibitor, a Hydroxyphenylpyruvate dioxygenase (HPPD) inhibitor, a synthetic auxin inhibitor, a protoporphyrinogen oxidase (PPO) inhibitor, a Glutamine Synthetase Inhibitor, a Microtubule inhibitor, a lipid synthesis inhibitor, a long chain fatty acid inhibitor, a cell wall inhibitor, a cell division inhibitor, a sulfonylurea herbicide, a Carotenoid Biosynthesis inhibitor, a bleaching inhibitor, a Cellulose inhibitor, a Photo system inhibitor, and a herbicide with unknown modes of action.

12. A herbicidal composition comprising herbicidal combination of:
at least one shoot growth inhibitor;
at least one herbicide, wherein the at least one herbicide is an amino-acid synthesis inhibitor; and
at least one agrochemically acceptable excipient.

13. A method of controlling weeds, said method comprising applying to weed, to their locus, or to crop a herbicidal combination comprising:
(a) at least one shoot growth inhibitor; and
(b) at least one amino-acid synthesis inhibitor.

14. The method according to claim 13,
wherein said at least one shoot growth inhibitor is a chloro acetamide compound, and
wherein said at least one amino-acid synthesis inhibitor is an Acetolactate Synthase (ALS) inhibitor or an Acetohydroxy Acid Synthase (AHAS) inhibitor.

15. The method according to claim 13, wherein said at least one shoot growth inhibitor and said at least one herbicide are applied simultaneously, separately, or sequentially in any sequence for synergistic control of weeds.

16. (canceled)

17. The combination according to claim 11, wherein said ACCase inhibitor (acetyl CoA carboxylase) is selected from the group consisting of aryloxyphenoxy-propionate, phenylpyrazoline, and cyclohexanedione.

18. The combination according to claim 11, wherein said photo system inhibitor is selected from the group consisting of a photosystem II inhibitor, a photosystem I (PSI) electron diverter, and a phytoene desaturase (PDS) inhibitor.
